(19) United States
(12) Patent Application Publication
(10) Pub. No.: US 2011/0042965 A1
(43) Pub. Date: Feb. 24, 2011

(54) WIND TURBINE POWER TRAIN

(75) Inventors: Kais Atallah, South Yorkshire (GB); Jan Jozef Rens, South Yorkshire (GB); Richard Edward Clark, South Yorkshire (GB)

Correspondence Address: HARTMAN & HARTMAN, P.C., 552 EAST 700 NORTH, VALPARAISO, IN, 46383, US

(73) Assignee: MAGNOMATICS LIMITED, Sheffield, South Yorkshire (UK)

(21) Appl. No.: 12/918,683

(22) PCT Filed: Feb. 20, 2009
(86) PCT No.: PCT/GB2009/000477

§ 371 Date: Nov. 4, 2010

(30) Foreign Application Priority Data
Feb. 21, 2008 (GB) 0803119.7
Apr. 23, 2008 (GB) 0807388.4
Jun. 3, 2008 (GB) 0810096.8
Jun. 3, 2008 (GB) 0810097.6
Jul. 18, 2008 (GB) 0813173.2

(51) Int. Cl. H02K 7/116; F03D 9/00

(52) U.S. Cl. 290/1 C; 290/44

(57) ABSTRACT

A wind turbine power train comprising a turbine rotor stage and drive shaft; an electric generator stage connected to the turbine rotor stage and a power electronic converter stage connected to the electric generator stage; wherein the electric generator stage comprises an electrical machine with integral magnetic gearing, an output of the electric generator stage being AC electrical power.

The present invention relates to wind turbine power trains.

In particular, the present invention relates to wind turbine power trains incorporating types of magnetic gearing. Such types of magnetic gearing may include magnetic gears as a direct replacement for mechanical gear stages; a variable magnetic gear to enable a constant frequency generator output and a so-called permanent magnet or wound field “pseudo direct drive”, which provides an electric generator with integral magnetic gearing. Such types of magnetic gearing may be used in combination with power electronic devices as appropriate.

Magnetic gears offer a number of advantages over mechanical gears, such as reduced wear, lubricant-free operation, reduced maintenance costs, and inherent overload protection, i.e. the gear will harmlessly slip when a torque higher than the maximum torque is applied and automatically re-engages when the torque is reduced below the maximum torque. Further, the range of gear ratios which can be achieved in a single stage is extensive, ranging between 1:1 to 50:1 for a conventional concentric radial or axial field gear to around 1000:1 for a cycloidal magnetic gear. Such a cycloidal magnetic gear is known from the Applicant's co-pending UK application GB 0611965.5, the contents of which are hereby incorporated in their entirety.

According to a first aspect of the present invention, there is provided a wind turbine power train comprising a turbine rotor stage and drive shaft; an electric generator stage connected to the turbine rotor stage and a power electronic converter stage connected to the electric generator stage; wherein the electric generator stage comprises an electrical machine with integral magnetic gearing, an output of the electric generator stage being AC electrical power.

According to a second aspect of the present invention, there is provided a wind turbine power train comprising a turbine rotor stage and first drive shaft; a variable magnetic gear stage connected to the turbine rotor stage and an electric generator stage connected to the variable magnetic gear stage, wherein the variable magnetic gear stage comprises a variable gear ratio magnetic coupling and the electric generator stage comprises an electrical machine with integral magnetic gearing, an output of the electric generator stage being AC electrical power.

According to a third aspect of the present invention, there is provided a wind turbine power train comprising a turbine rotor stage and drive shaft; a first gear stage connected to the turbine rotor stage and an electric generator stage connected to the gear stage; a power electronic converter stage connected to the electric generator stage; wherein an output of the electric generator stage is AC electrical power and the gear stage comprises a magnetic gear.

Preferred embodiments are defined in the dependent claims.

Embodiments of the invention will now be described, by way of example only, and with reference to the accompanying drawings in which:

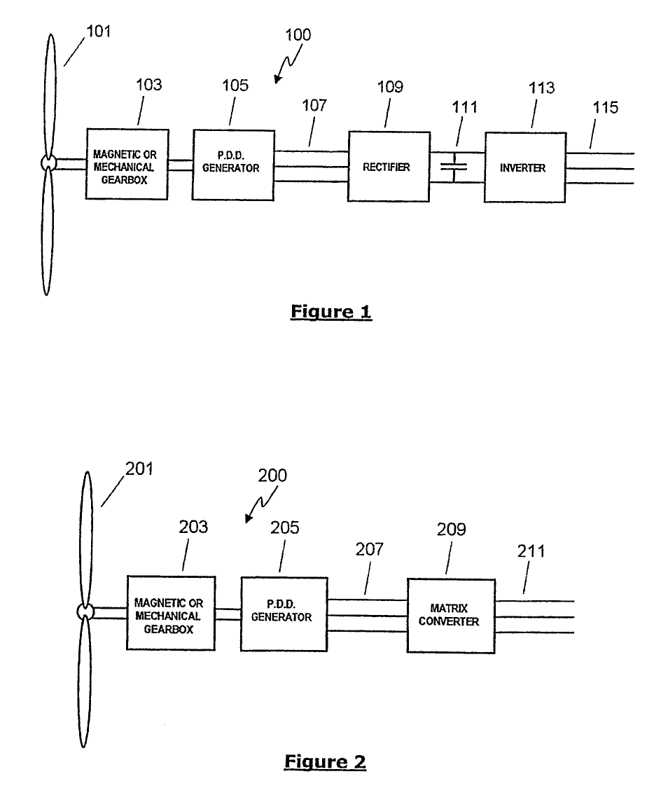

FIG. 1 is a schematic diagram of a wind turbine power train according to a first embodiment of the present invention;

FIG. 2 is a schematic diagram of a wind turbine power train according to a second embodiment of the present invention;

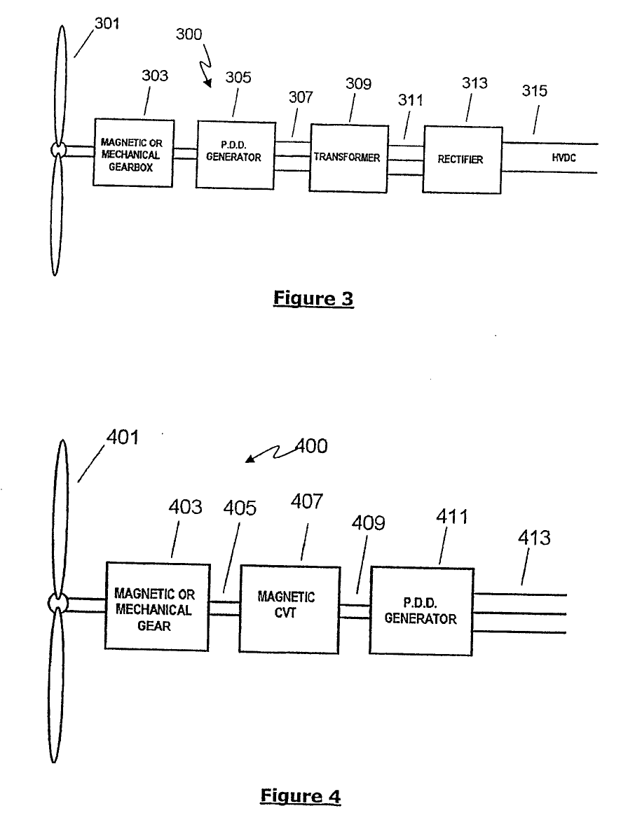

FIG. 3 is a schematic diagram of a wind turbine power train according to a third embodiment of the present invention;

FIG. 4 is a schematic diagram of a wind turbine power train according to a fourth embodiment of the present invention;

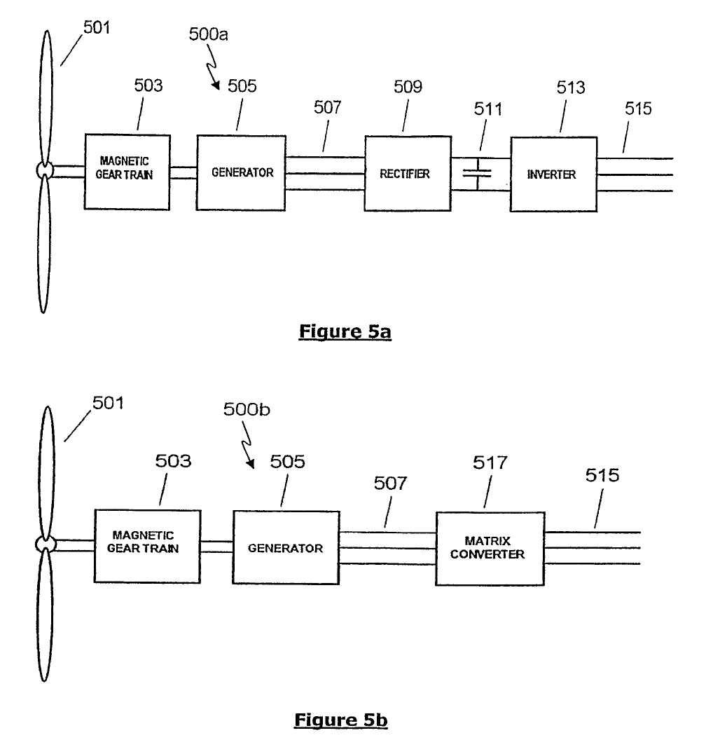

FIGS. 5a and 5b are a schematic diagram of a wind turbine power train 10 according to a fifth embodiment of the present invention;

FIG. 5c is a schematic diagram of a wind turbine power train according to a further embodiment of the present invention;

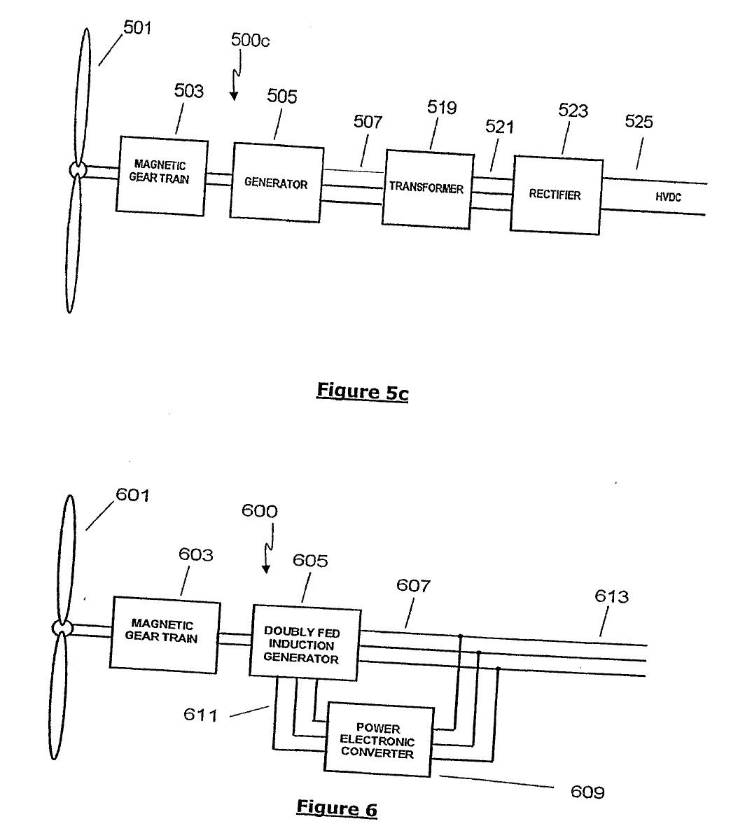

FIG. 6 is a schematic diagram of a wind turbine power train according to a sixth embodiment of the present invention;

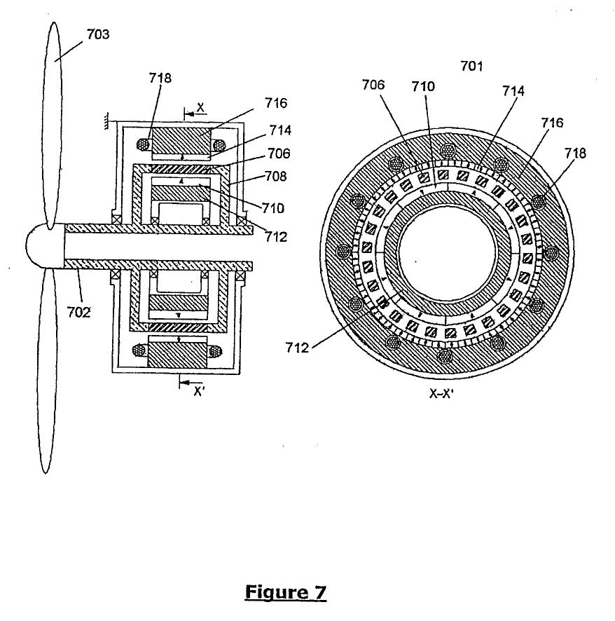

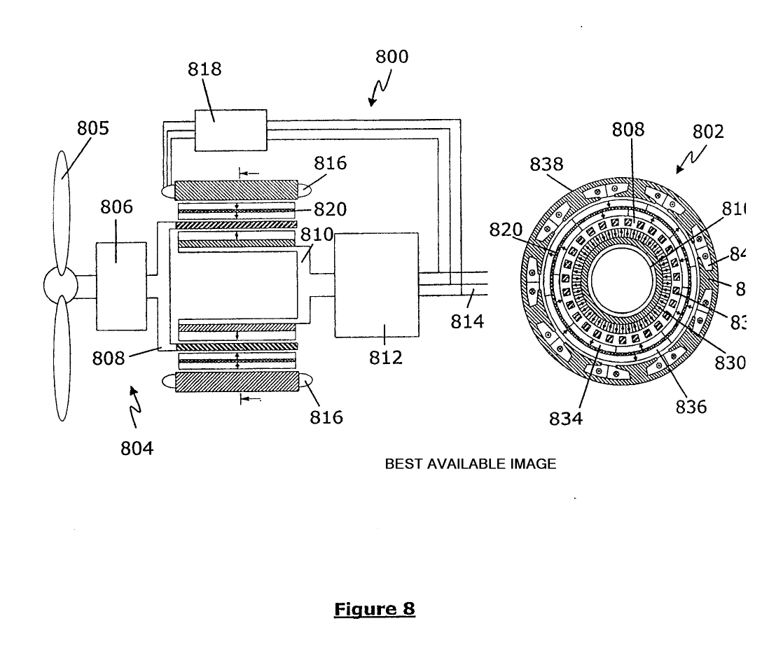

FIG. 7 is a schematic diagram of a wind turbine power train including a direct driven pseudo direct drive according to a seventh embodiment of the present invention;

FIG. 8 is a schematic diagram of a wind turbine power train including a variable magnetic gear according to an eighth embodiment of the present invention;

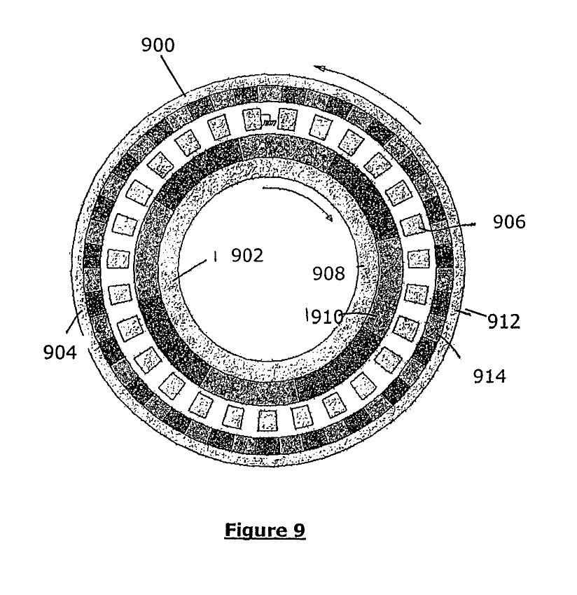

FIG. 9 is a schematic through a known rotary magnetic gearing system applicable to embodiments of the present invention;

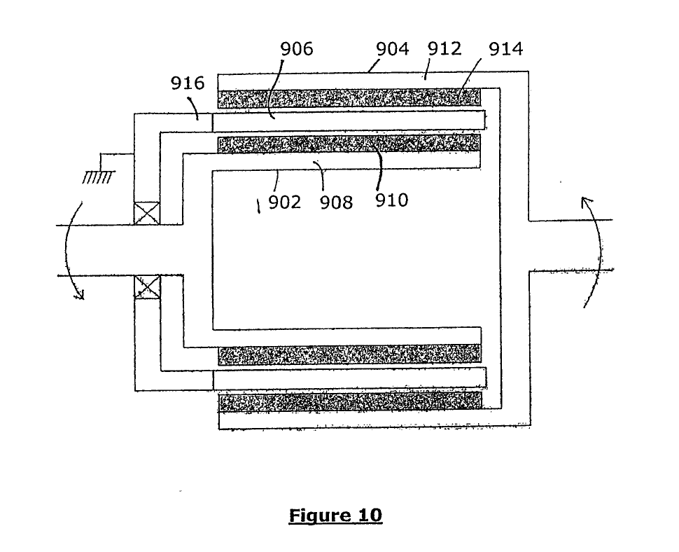

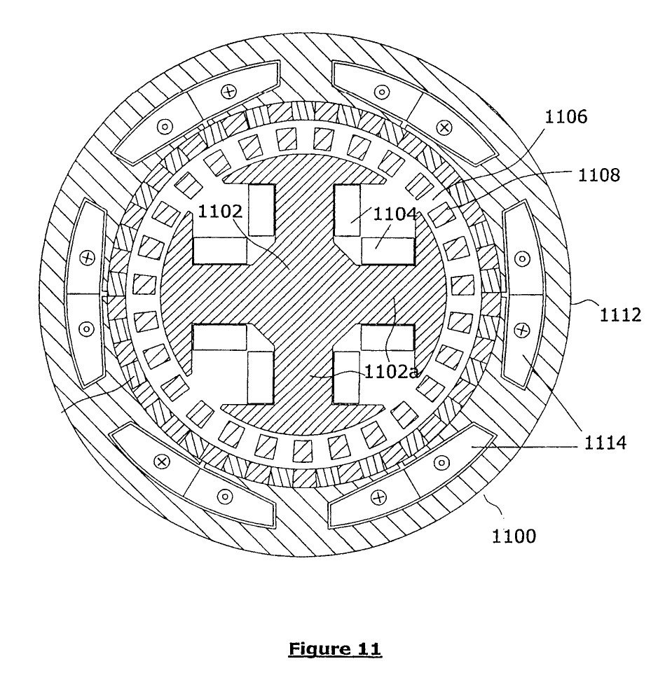

FIG. 10 is a longitudinal section through the gearing system of FIG. 9; and

FIG. 11 is a schematic of a wound field combined electrical machine and magnetic gear according to an embodiment of the present invention.

Referring to FIG. 1, a wind turbine power train 100 according to a first embodiment of the present invention comprises a turbine 101 connected to an optional gear train 103. The gear train 103 is optional because it is not present in a direct drive system as described in accordance with a seventh embodiment 10 of the present invention. The gear train 103 may be mechanical or magnetic, or a combination with magnetic and mechanical gear stages. A magnetic gear stage may be a permanent magnet, wound field or combination and a person skilled in the art is aware of various suitable mechanical gear stages. Further details of magnetic gears applicable to the present invention are described in accordance with FIGS. 9 and 10 of the present invention.

The gear train 103 is connected to a Pseudo Direct Drive (PDD) generator 105. Pseudo-direct drive generators are electrical machines with integral magnetic gearing and may comprise at least one stator and two moveable elements, such as inner and outer rotors, which interact in a magnetically geared manner via asynchronous harmonics of first and second pluralities of permanent magnets. Such assemblies are described in various embodiments in GB 2437568. The POD 105 may be a permanent magnet or wound field excitation as described in further detail in accordance with FIGS. 7 and 11 respectively.

In operation, an output 107 of the POD 105 is a multiple phase, variable frequency and amplitude AC electrical power. The output 107 is passed to a power electronic converter stage comprising a rectifier 109, an intermediate DC bridge 111 and an inverter 113. The rectifier 109 may be an active or a passive rectifier and in operation converts the AC electrical power to a DC voltage and current. The inverter 113 regulates the DC voltage and current and converts the DC voltage and current back to a constant frequency AC electrical power for utility grid connection 115.

Referring to FIG. 2, a wind turbine power train 200 according to a second embodiment of the present invention comprises a turbine 201 connected to a an optional gear train 203. The gear train 203 is optional because it is not present in a direct drive system as described in accordance with a seventh 15 embodiment of the present invention. The gear train 203 may be mechanical or magnetic or a combination with both magnetic and mechanical gear stages. A magnetic gear stage may be a permanent magnet, wound field or combination and a person skilled in the art is aware of various suitable mechanical gear stages. Further details of magnetic gears applicable to the present invention are described in accordance with FIGS. 9 and 10 of the present invention.

The gear train 203 is connected to a Pseudo Direct Drive (PDD) generator 205. Pseudo-direct drive generators are electrical machines with integral magnetic gearing and may comprise at least one stator and two moveable elements, such as inner and outer rotors, which interact in a magnetically geared manner via asynchronous harmonics of first and second pluralities of permanent magnets. Such assemblies are described in various embodiments in GB 2437568, which are incorporated herein by reference. The PDD 205 may be a permanent magnet or wound field excitation as described in further detail in accordance with FIGS. 7 and 11 respectively.

In operation, an output 207 of the PDD 205 is a multiple phase, variable frequency and amplitude AC electrical power. The output 207 is passed to a power electronic converter stage comprising an AC to AC matrix converter 209 with a fixed frequency output suitable for utility grid connection 211.

Referring to FIG. 3, a wind turbine power train 300 according to a third embodiment of the present invention comprises a turbine 301 connected to an optional gear train 303. The gear train 303 is optional because it is not present in a direct drive system as described in accordance with a seventh embodiment of the present invention. The gear train 303 may be mechanical or magnetic or a combination of both with mechanical and magnetic gear stages. A magnetic gear stage may be a permanent magnet, wound field or combination and a person skilled in the art is aware of various suitable mechanical gear stages. Further details of magnetic gears applicable to the present invention are described in accordance with FIGS. 9 and 10 of the present invention.

The gear train 303 is connected to a Pseudo Direct Drive (POD) generator 305. Pseudo-direct drive generators are electrical machines with integral magnetic gearing and may comprise at least one stator and two moveable elements, such as inner and outer rotors, which interact in a magnetically geared manner via asynchronous harmonics of first and second pluralities of permanent magnets. Such assemblies are described in various embodiments in GB 2437568, which are incorporated herein by reference. The POD 305 may be a permanent magnet or wound field excitation as described in further detail in accordance with FIGS. 7 and 11 respectively.

In operation, an output 307 of the POD 305 is a multiple phase, variable frequency and amplitude AC electrical power. The output 207 is passed to a power electronic converter stage comprising a step-up transformer 309 and a rectifier 313. In operation, the step-up transformer 309 outputs a high voltage via a multiple phase bus 313 to the rectifier 313. The rectifier 313 may be an active or a passive rectifier and in operation converts the AC electrical power to a DC voltage and current suitable for High Voltage Direct Current (HVDC) transmission 315 to connect to a HVDC grid system. Alternatively, the HVDC transmission 315 may connect to an inverter located in a close proximity to the wind turbine.

Referring to FIG. 4, a wind turbine power train 400 according to a fourth embodiment of the present invention comprises a turbine 401 connected to an optional gear train 403. The gear train 403 may be mechanical or magnetic. A magnetic gear train may be a permanent magnet, wound field or combination and a person skilled in the art is aware of various suitable mechanical gear stages. Further details of magnetic gears applicable to the present invention are described in accordance with FIGS. 9 and 10 of the present invention.

Where present and in operation, the gear train 403 provides a geared up variable speed drive connected to a variable magnetic gear stage 407. In operation, the variable magnetic gear stage 407 provides a fixed output speed with a variable input speed. The variable magnetic gear stage 407 is described in further detail in FIG. 8.

In operation, an output of the magnetic gear stage 407 is a constant drive speed 409 connected to a wound field Pseudo Direct Drive (POD) generator 411. The wound field POD generator 411 is described in further detail in accordance with FIG. 11. The POD generator in operation outputs a fixed frequency output AC electrical power suitable for utility grid connection 211.

Although a wound filed POD generator is preferred, a permanent magnet POD 15 generator as described herein can be used.

Referring to FIGS. 5a, 5b and 5c, a wind turbine power train 500a and 500b according to a fifth embodiment of the present invention comprises a turbine 501 connected to a magnetic gear train 503. The magnetic gear train 503 may be a permanent magnet, wound field or combination or cycloidal gear.

Further details of magnetic gears applicable to the present invention are described in accordance with FIGS. 9 and 10 of the present invention. The magnetic gears can be provided as separate gears or included as part of a gear train including a mechanical gear stage followed by a number of magnetic gear stages or vice versa.

The magnetic gear train 503 is connected to an electric generator 505. Suitable electric generators are known in the art and may comprise a wound field or permanent magnet excited electric generator. In operation, an output 507 of the generator 505 is a multiple phase, variable frequency and amplitude AC electrical power.

The output 507 of the generator 505 is passed to a power electronic converter stage comprising, as illustrated in FIG. 5a, a rectifier 509, an intermediate DC bridge 511 and an inverter 513. The rectifier 509; may be an active or a passive rectifier and in operation converts the AC electrical power to a DC voltage and current. The inverter 513 regulates the DC voltage and current and converts the DC voltage and current back to a constant frequency AC electrical power for utility grid connection 515.

Alternatively, the output 507 of the generator 505 is passed to a power electronic converter stage, as illustrated in FIG. 5b, comprising an AC to AC matrix converter 209 with a fixed frequency output suitable for utility grid connection 211.

Alternatively, and as illustrated in FIG. 5c the output 507 of the generator 505 is passed to a power electronic converter stage comprising a step-up transformer 519 and a rectifier 523. In operation, the step-up transformer 519 outputs a high voltage via a multiple phase bus 521 to the rectifier 523. The rectifier 523 may be an active or a passive rectifier and in operation converts the AC electrical power to a DC voltage and current suitable for High Voltage Direct Current (HVDC) transmission 525 to connect to a HVDC grid system.

Alternatively, the HVDC transmission 525 may connect to an inverter located in a close proximity to the wind turbine.

Referring to FIG. 6, a wind turbine power train 600 according to a sixth embodiment of the present invention comprises a turbine 601 connected to a magnetic gear train 603. The magnetic gear train 603 may be a permanent magnet, wound field or combination. Further details of magnetic gears applicable to the present invention are described in accordance with FIGS. 9 and 10 of the present invention.

In operation, the magnetic gear train 603 provides a variable speed input to a Doubly Fed Induction Generator (DFIG) 605. Suitable DFIGs 605 are known in the art. A power electronic converter 609 is connected in feedback between an output 607 of the DFIG 605 and an input 611 to the DFIG 605 to provide a variable frequency drive to induction generator rotor windings of the DFIG 605.

The output 607 of the DFIG 605 is a multiple phase, fixed frequency and amplitude AC electrical power suitable for connection to a utility grid 613.

Referring to FIG. 7, a wind turbine power train 700 including a direct driven pseudo direct drive 701 according to a seventh embodiment of the present invention.

A person skilled in the art will understand that the seventh embodiment is applicable to any of the embodiments described herein using a POD. In particular, various magnetic or mechanical gear stages (or combinations of the two) may be provided between the POD and the turbine and various power electronic devices may be provided in the power train after the POD.

The wind turbine power train 700 comprises a turbine rotor 702 which has a number of blades 703 arranged to be rotated by the wind at variable speed.

Rotation of the turbine rotor 702 causes rotation of pole-pieces 704 mounted on pole-piece rotor 706. Rotation of pole piece rotor 704,706 causes rotation of inner PM rotor 712/704, which has set of permanent magnets 704 mounted on a carrier 712, due to the presence of an outer set of static magnets 714. The pole pieces 706 act to modulate the fields of the permanent magnet arrays 710 and 714 to enable the field from one to couple to the other by producing an asynchronous harmonic with the correct pole pattern to allow coupling and production of torque. Although the pole pieces modulate the field due to the inner rotor magnets 710, the main field with the same pole number as the magnet array 710 is also present within the stator 716 and this field couples with the Windings 718 to induce ac voltages as the inner rotor 712/704 rotates in a gear manner when the pole piece rotor 706 rotates. The output of the POD machine 701 is therefore not synchronous with the input rotor 704.

Referring to FIG. 8, a wind turbine power train 800 including a variable magnetic gear 802 according to an eighth embodiment of the present invention comprises a turbine rotor 804 which has a number of blades 805 arranged to be rotated by the wind at variable speed.

The turbine rotor 804 is connected via a mechanical or magnetic transmission 806 to the input rotor 808 of a variable gear ratio magnetic coupling 802, which is a pole piece rotor. Although present in the eighth embodiment, the mechanical or magnetic transmission 806 is optional and not required in a direct drive arrangement in which the variable magnetic gear 802 is directly connected to the turbine rotor 804.

An output rotor 810, of the variable magnetic gear, is connected to a constant speed electrical generator 812 which may be directly connected to the 3-phase electrical grid 814 controlled voltages/currents are supplied to the coils of an electrical machine stator 816 through a control system 818 which includes a power-electronics converter which is connected to the electrical grid 814. The control system 818 is arranged to control the speed of an outer rotor 820, in order to change the gear ratio of the variable gear 802 so that the variable speed of the input rotor 808 results in a constant or near constant speed of the output rotor 810. The torque which must be applied on the outer rotor 820 by the electrical machine 816 is governed by the torque on the blades 805, and is always in an identical direction which does not depend on wind speed. The speed and direction at which the outer rotor 820 is rotated by the electrical machine 816 is varied as a function of the wind speed. The control system 818 is thus arranged to take power from the grid 814 to make the electrical machine 816 operate as a motor when it drives the outer, gear ratio controlling, rotor 820 in the same direction to the torque, or to provide power to the grid to make the electrical machine operate as a generator when it drives the outer rotor 820 in the opposite direction to the torque. The electrical machine 816 therefore acts as a motor/generator under the control of the control system 818. The control system includes speed sensors arranged to sense the speed of each of the rotors 808 and 820 to enable it to provide the required speed control.

At the nominal wind speed of the wind turbine, the required gear ratio between the speed of the blades 805 and the speed of the main generator 812 is equal to the nominal gear ratio of the drive train, which results from the combination of the fixed gear and the variable gear with a stationary outer rotor 820. At this wind speed, the electrical machine 816 is controlled to apply a torque on the outer rotor 820 and to keep the outer rotor 820 stationary, and there is no power flow between the electrical machine 816 and the variable gear 802.

At low wind speeds, the required gear ratio between the speed of the blades 805 and the constant speed of the main generator 812 is greater than the nominal gear ratio of the drive train. Hence, the electrical machine 816 is operated to rotate the outer rotor 820 of the variable gear 802 to adjust the overall gear ratio, while the direction of the torque that the motor/generator applies on the outer rotor 820 remains unchanged. Therefore, power is taken from the grid 814 into the electrical machine 816, i.e. the electrical machine 816, in the variable gear 802 operates as a motor. This power then flows through the main electrical generator 812 back into the grid 814. The power through the main electrical generator 812 is greater than the total generated power. At high wind speeds, the required gear ratio between the speed of the blades 805 and the constant speed of the main generator 812 is smaller than the nominal gear ratio of the drive train. The electrical machine 816 is operated to rotate the outer rotor 820 of the variable gear to adjust the overall gear ratio in a direction which is opposite to the direction of rotation at low wind speeds, while the direction of the torque that the motor/generator applies on the outer rotor 820 remains unchanged. Therefore, the electrical machine 816 works as a generator. Part of the available wind power flows through the variable gear 802 and its electrical machine into the grid, and the remainder of the available power flows through the main electrical generator 812. The power through the main generator 812 is therefore smaller than the total generated power.

Because at peak power (high wind speed), the electrical machine 816 works as a generator and therefore assists the main electrical generator, the main electrical generator 812 can be smaller and cheaper.

This arrangement allows for a constant speed electrical generator 812 to be directly connected to the grid 814, whilst the blades 805 can operate at a speed that maximizes energy capture. Therefore there is no need for power electronics between the electrical generator 812 and the electrical grid 814.

The power needed to control the variable gear 802 depends on the wind speed, but is generally no more than 25% of the power which is generated by the entire turbine 800. The power electronics 818 in the entire system is therefore much smaller than would be required if no variable gear was used. Also, because most of the power does not go through power electronics, the efficiency is high.

It will be understood by those skilled in the art that the electric machine 816 need not be connected to the grid through a controller 818, but can be connected to a separate external power supply. Such an arrangement could for example be utilized in power generation systems which work in island operation, where the grid is absent at the start of the operation, such that, for example, an additional battery pack or a separate power source is required to operate the electrical machine 816 at start-up. For smaller power generation systems, the electrical machine 816 could be connected to a separate power supply in continuous operation.

It will be further understood by those skilled in the art that function performed by the controller 818 and machine stator 816 may be performed by a mechanical transmission such as a clutch or hydraulic feedback mechanism to control the speed and torque applied to the rotor 820.

In further detail, the variable magnetic gear 802 comprises the output rotor 810 with its associated set of magnets 830, and the input rotor, the pole-piece rotor 808 carrying the pole pieces 832, and the outer rotor 820 forms the gear ratio control rotor. In this case the outer rotor 820 is driven by a permanent magnet electrical machine. To this end, the outer rotor 820 includes an inner array of magnets 834 which cooperate with the pole pieces 832 and the magnets on the output rotor 810 to provide the gearing, and an outer array of magnets 836 which form part of the permanent magnet electrical machine. A stator 838 is provided radially outside the outer rotor 820, and comprises a series of coils 840 wound on ferromagnetic cores 842. The current flowing in these coils can be controlled to control the driving torque applied to the outer rotor 820 via the outer array of magnets 836. This enables the speed of rotation of the outer rotor 820 to be controlled, and hence the gear ratio of the gear to be varied and controlled.

Referring to FIGS. 9 and 10, a known rotary magnetic gear 900 applicable to embodiments of the present invention comprises a first or inner rotor 902, a second or outer rotor 904 having a common axis of rotation with the first rotor 902, and a number of pole pieces 906 of ferromagnetic material supported between the rotors 902, 904. The first rotor 902 comprises a support 908 carrying a first set of permanent magnets 910, arranged with their north and south poles at their radially inner and outer ends, and orientated with alternating polarity so that each of the magnets 910 has its poles facing in the opposite direction to the magnets on either side of it. In this embodiment, the first rotor 902 comprises eight permanent magnets, or four pole-pairs, arranged to produce a spatially varying magnetic field. The second rotor 904 comprises a support 912 carrying a second set of permanent magnets 914, again arranged with their poles facing radially inwards and outwards, and with alternating polarity. The second rotor 904 comprises 46 permanent magnets or 23 pole-pairs arranged to produce a spatially varying field. The first and second sets of permanent magnets therefore include different numbers of magnets. Accordingly, without any modulation of the magnetic fields they produce, there would be little or no useful magnetic coupling or interaction between the two sets of permanents magnets 910 and 914 such that rotation of one rotor would not cause rotation of the other rotor.

The pole pieces 906, which may be supported in a cylindrical non-magnetic support 916, are used to control the way in which the fields of the permanent magnets 910 and 914 interact. The pole pieces 906 modulate the magnetic fields of the permanent magnets 910 and 914 so that they interact to the extent that rotation of one rotor will induce rotation of the other rotor in a geared manner. The number of pole pieces is chosen to be equal to the sum of the number of pole-pairs of the two sets of permanent magnets. Rotation of the first rotor 902 at a speed ω₁ will induce rotation of the second rotor 104 at a speed ω₂ where ω₁>ω₂. The ratio between the speeds of rotation ω₁ and ω₂, i.e. the gearing ratio of the coupling, is equal to the ratio between the numbers of pole pairs of the magnets 910 and 914 on the first and second rotors 902, 904. The gear can operate in reverse, so that rotation of the second rotor 904 will cause rotation of the first rotor at a higher speed. Additionally, a preferred arranged includes rotating the pole pieces 906 whilst holding the second rotor 904 static.

Referring to FIG. 11, a wound field combined electrical machine and magnetic gear applicable to embodiments of the present invention is exemplified in the applicant's co-pending UK patent application GB 0810096.8 which is hereby incorporated in its entirety by reference.

FIG. 11 shows an electrical machine 1100 according to a first preferred embodiment of the present invention. The electrical machine 1100 comprises an inner rotor 1102 bearing a number of electrical windings 1104 which form electromagnets. The windings 1104 are fitted or wound around salient teeth 1102a of the inner rotor 1102, such that each tooth 1102a forms a magnetic pole when the respective winding 1104 is supplied with a current.

The windings 1104 are arranged to be electrically energized via one or more of slip rings, a rotating supply or a transformer due to being mounted upon the rotatable inner rotor 1102. When energized with an electrical current I the windings 1104 create a magnetic field having a required number of poles. In the shown embodiment, the windings 1104 are arranged to form a magnetic field having four magnetic poles although it will be realized that other numbers and arrangements of windings may be provided to provide other numbers of pole-pairs.

The electrical machine 1100 comprises an outer rotor 1106 carrying a number of ferromagnetic pole-pieces 1108. In the illustrated embodiment, the outer rotor 1106 carries 27 pole-pieces 1108 that enable magnetic coupling using asynchronous harmonics between the field produced by the windings 1104 of the inner rotor 1102 and a number of permanent magnets 1110 that are mounted to a fixed stator 1112. The stator 1112 has 6 teeth around which 6 coils 1114 are concentrically wound to form a 3-phase winding, although a wide range of possible winding arrangements may also be employed.

The stator windings 1114 magnetically couple with a fundamental harmonic of the field produced by the inner rotor windings 1104 so that a torque is applied on the inner rotor 1102. In preferred embodiment, the stator winding 1114 is 3-phase and is arranged into 6 slots, but can equally well be some other type of winding such as, for example, a distributed winding within a high number of slots as is typical in a conventional synchronous machine. The embodiment illustrated comprises 50 poles of permanents magnets 1110 disposed on an interior periphery of the stator 1112. The pole-pieces 1108 of the outer rotor 1106 are arranged to provide gearing between the inner rotor 1102 and the outer rotor 1106. In preferred embodiments, the gearing is such that the inner rotor 1102 is a relatively high-speed rotor and the outer rotor 1106 is a relatively low speed rotor. The shown embodiment has a gear ratio of 13.5:1.

The pole-pieces 1108 are used to allow the fields of the permanent magnets 1110 and the inner rotor windings 1104 to interact. The pole-pieces 1108 modulate the magnetic fields of the permanent magnets 1110 and those of the inner rotor windings 1104 so they interact to the extent that rotation of one rotor will induce rotation of the other rotor in a geared manner. Rotation of the first rotor 1102 at a speed ω₁ will induce rotation of the second rotor 1106 at a speed ω₂ where ω₁>ω₂ and vice versa.

One skilled in the art understands how to select and design the pole-pieces 1108, given the permanent magnets 1110 and windings 1104, to achieve the necessary magnetic circuit or coupling such that gearing between the first 1102 and second 1106 rotors results, as can be appreciated from, for example, K. Atallah, D. Howe, “A novel high-performance magnetic gear”, IEEE Transactions on Magnetics, Vol. 37, No. 4, pp. 2844-2846, 2001 and K. Atallah, S. D. Calverley, D. Howe, “Design, analysis and realization of a high performance magnetic gear”, IEE Proceedings—Electric Power Applications, Vol. 151, pp. 135-143, 2004, and GB 2 437 568 which are incorporated herein by reference for all purposes.

No doubt many other effective alternatives will occur to the skilled person. It will be understood that the invention is not limited to the described embodiments and encompasses modifications apparent to those skilled in the art lying within the spirit and scope of the claims appended hereto.

A wind turbine power train comprising a turbine rotor stage and drive shaft; an electric generator stage connected to the turbine rotor stage and a power electronic converter stage connected to the electric generator stage; wherein the electric generator stage comprises an electrical machine with integral magnetic gearing, an output of the electric generator stage being AC electrical power.

1. A wind turbine power train comprising a turbine rotor stage and drive shaft; an electric generator stage connected to the turbine rotor stage and a power electronic converter stage connected to the electric generator stage; wherein the electric generator stage comprises an electrical machine with integral magnetic gearing, an output of the electric generator stage being AC electrical power.

2. A wind turbine power train according to claim 1, wherein the electrical machine with integral magnetic gearing comprises a first rotor having a first set of permanent magnets comprising a first number of pole pairs; a second set of permanent magnets having a respective second number of pole pairs such that the first and second numbers of pole pairs are different; a plurality of pole pieces mounted on a second rotor; and a winding arranged to interact with the fundamental space harmonic of the first set of permanent magnets of the first rotor.

3. A wind turbine power train as claimed in claim 2, wherein the first rotor and the second rotor are arranged to interact, when in use, in a magnetically geared manner via asynchronous harmonics of the first and second sets of permanent magnets such that rotation of the second rotor induces a geared rotation of the first rotor.

4. A wind turbine power train according to claim 2, wherein the plurality of pole pieces mounted on the second rotor are outwardly disposed to the first rotor, and the second set of permanent magnets and the winding are mounted on a stationary armature outwardly disposed to the second rotor.

5. A wind turbine power train according to claim 2, wherein the plurality of pole pieces mounted on the second rotor are inwardly disposed to the first rotor, and the second set of permanent magnets and the winding are mounted on a stationary armature inwardly disposed to the second rotor.

6. A wind turbine power train according to claim 2, wherein the second set of permanent magnets comprise an inner stator, the second rotor is outwardly disposed to the inner stator, the first rotor is disposed outwardly to the first rotor; and the winding is mounted on a stationary armature outwardly disposed to the first rotor.

7. A wind turbine power train according to claim 2, wherein the winding is mounted on an inner stationary armature inwardly disposed to the first rotor, the second rotor is outwardly disposed to the first rotor and the second set of permanent magnets are outwardly disposed to the second rotor.

8. A wind turbine power train according to claim 1, wherein the electrical machine with integral magnetic gearing comprises a first rotor comprising a first electrical winding, a set of permanent magnets having a respective number of pole pairs and a second rotor comprising a plurality of pole pieces; and a second electrical winding arrangement arranged to interact magnetically with a fundamental harmonic of a magnetic field created by the first electric winding arrangement associated with the first rotor.

9. A wind turbine power train according to claim 8, wherein the plurality of pole pieces are arranged to, when in use, modulate the magnetic fields created, at least in part, by the first electrical winding and the set of permanent magnets in a magnetically geared manner via asynchronous harmonics of the first electrical winding and set of permanent magnets such that rotation of the second rotor induces a geared rotation of the first rotor.

10. A wind turbine power train according to claim 8, wherein the plurality of pole pieces mounted on the second rotor are outwardly disposed to the first rotor, and the set of permanent magnets and the second electrical winding are mounted on a stationary armature outwardly disposed to the second rotor.

11. A wind turbine power train according to claim 8, wherein the plurality of pole pieces mounted on the second rotor are inwardly disposed to the first rotor, and the set of permanent magnets and the second electrical winding are mounted on a stationary armature inwardly disposed to the second rotor.

12. A wind turbine power train according to claim 8, wherein the set of permanent magnets comprise an inner stator, the second rotor is outwardly disposed to the inner stator, the first rotor is disposed outwardly to the first rotor; and the second electrical winding is mounted on a stationary armature outwardly disposed to the first rotor.

13. A wind turbine power train according to claim 8, wherein the second electrical winding is mounted on an inner stationary armature inwardly disposed to the first rotor, the second rotor is outwardly disposed to the first rotor and the second set of permanent magnets are outwardly disposed to the second rotor.

14. A wind turbine power train according to claim 1, wherein the second rotor is connected to be driven by the drive shaft.

15. A wind turbine power train according to claim 1, wherein the first and second rotors and the stationary armature are at least one of annular or disc shaped, and axially disposed along the axis of rotation thereby forming an axial field rotary electrical machine.

16. A wind turbine power train according to claim 1, wherein the power electronic convertor stage comprises a rectifier connected to the output of the electric generator stage, an output of the rectifier being DC electrical power; and, an inverter connected to the output of the rectifier, an output of the inverter being AC electrical power.

17. A wind turbine power train according to claim 1, wherein the power electronic converter stage comprises an AC to AC matrix converter connected to the output of the electric generator stage with a fixed frequency AC electrical power output.

18. A wind turbine power train according to claim 1, wherein the power electronic convertor stage comprises a step-up transformer connected to the output of the electric generator stage an output of the transformer being a stepped-up AC electrical power; a rectifier connected to the output of the transformer, an output of the rectifier being DC electrical power; and a High Voltage DC transmission grid connected to the output of the rectifier.

19. A wind turbine power train according to claim 5, wherein the rectifier is active or passive.

20. A wind turbine power train according to claim 1, wherein a gear stage is connected between the turbine rotor stage and the electric generator stage.
